(19) United States
(12) Patent Application Publication
(10) Pub. No.: US 2021/0123777 A1
(43) Pub. Date: Apr. 29, 2021

(54) AUTOMOTIVE SENSOR INTEGRATION MODULE

(71) Applicant: HYUNDAI MOBIS CO., LTD., Seoul (KR)

(72) Inventors: Young Shin KIM, Yongin-si (KR); Won Gyum KIM, Yongin-si (KR); Kyung Rin KIM, Yongin-si (KR); Sung Eun JO, Yongin-si (KR)

(21) Appl. No.: 16/726,715

(22) Filed: Dec. 24, 2019

(30) Foreign Application Priority Data
Oct. 24, 2019 (KR) 10-2019-0133131

(51) Int. Cl. G01D 11/24; B60K 35/00

(52) U.S. Cl. CPC G01D 11/245; B60K 35/00

(57) ABSTRACT

An automotive sensor integration module including a plurality of sensors which differ in at least one of a sensing period or an output data format, an interface unit configured to convert pieces of detection data outputted from the plurality of sensors into a predetermined data format and output the converted detection data as conversion data, and a signal processing unit configured to convert the conversion data into data according to a predetermined coordinate system to generate a plurality of pieces of conversion data, and synchronize and output the conversion data on the basis of any one of the plurality of pieces of conversion data.

### CROSS-REFERENCE TO RELATED APPLICATION

This application claims priority from and the benefit of Korean Patent Application No. 10-2019-0133131, filed on Oct. 24, 2019, which is hereby incorporated by reference for all purposes as if set forth herein.

### BACKGROUND

### Field

Exemplary embodiments relate to an automotive sensor integration module.

### Discussion of the Background

As technology becomes more advanced, various sensors, electronic devices, and the like are also provided in a vehicle for user convenience. In particular, research regarding an advanced driver assistance system (ADAS) has been actively conducted for users' driving convenience. Furthermore, the development of autonomous vehicles is actively under way.

The ADAS and the autonomous vehicles require a large number of sensors and electronic devices to identify objects outside a vehicle.

Referring to FIG. 1, in order to detect objects in front of a vehicle, a camera, a lidar, a radar sensor, etc., are disposed in front of the vehicle, but are disposed at different positions, respectively.

Although objects should be identified on the basis of detection results detected by sensors at the same timing in order to improve performance in detecting objects, it is not easy to synchronize object detection sensors because the sensors are disposed at different positions. In addition, when contaminants are attached to the outer cover surface of the sensors, it becomes more difficult for each sensor to output the detection result for the normal object discrimination.

In addition, at least one or more of the sensors have a different format of detection results outputted from the other sensors, and thus, it is not easy to identify an object on the basis of the detection results outputted from each sensor.

The above information disclosed in this Background section is only for enhancement of understanding of the background of the invention and, therefore, it may contain information that does not constitute prior art.

### SUMMARY

Exemplary embodiments of the present invention provide an automotive sensor integration module in which a plurality of synchronized sensors are arranged.

The inventive concepts are are not limited to the above-mentioned exemplary embodiments, and other aspects and advantages of the present invention, which are not mentioned, will be understood through the following description, and will become apparent from the embodiments of the present invention. Furthermore, it will be understood that aspects and advantages of the present invention can be achieved by the means set forth in the claims and combinations thereof.

An exemplary embodiment of the present invention provides an automotive sensor integration module including a plurality of sensors which differ in at least one of a sensing period or an output data format, an interface unit configured to convert pieces of detection data outputted from the plurality of sensors into a predetermined data format and output the converted detection data as conversion data, and a signal processing unit configured to convert the conversion data into data according to a predetermined coordinate system to generate a plurality of pieces of conversion data, and synchronize and output the conversion data on the basis of any one of the plurality of pieces of conversion data.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating the exterior of an autonomous vehicle.

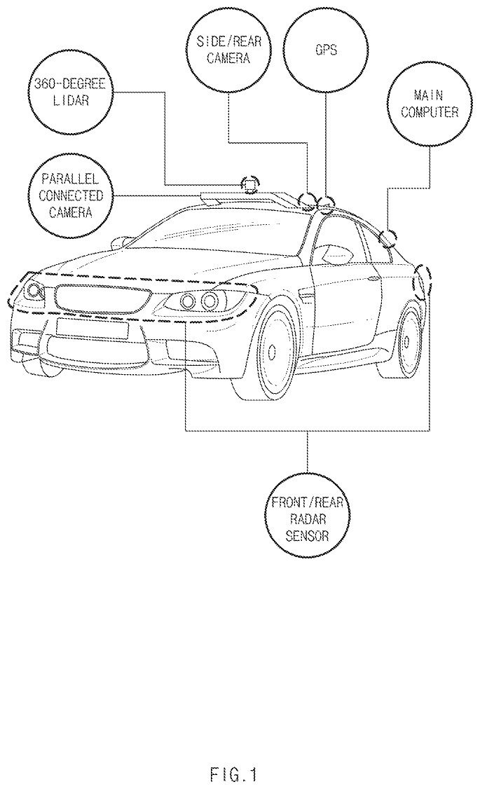

FIG. 2 is a diagram illustrating an external view of an automotive sensor integration module according to an exemplary embodiment of the present invention.

FIG. 3 is a diagram illustrating a configuration of an automotive sensor integration module according to an exemplary embodiment of the present invention.

FIG. 4 is a diagram illustrating a configuration of a signal processing unit of FIG. 3.

FIG. 5 is a diagram for explaining an automotive sensor integration module according to an exemplary embodiment of the present invention.

### DETAILED DESCRIPTION OF THE ILLUSTRATED EMBODIMENTS

The above objects, features, and advantages will be described in detail with reference to the accompanying drawings so that those skilled in the art can easily implement the technical concept of the present invention. Detailed descriptions of well-known technologies related to the present invention will not be provided in order not to unnecessarily obscure the gist of the present invention. Hereinafter, exemplary embodiments of the present invention will be described in detail with reference to the accompanying drawings. In the drawings, the same reference numerals refer to the same or similar elements.

Unless defined otherwise, it is to be understood that all the terms (including technical and scientific terms) used in the specification has the same meaning as those that are understood by those who skilled in the art. Further, the terms defined by the dictionary generally used should not be ideally or excessively formally defined unless clearly defined specifically. It will be understood that for purposes of this disclosure, “at least one of X, Y, and Z” can be construed as X only, Y only, Z only, or any combination of two or more items X, Y, and Z (e.g., XYZ, XYY, YZ, ZZ). Unless particularly described to the contrary, the term “comprise”, “configure”, “have”, or the like, which are described herein, will be understood to imply the inclusion of the stated components, and therefore should be construed as including other components, and not the exclusion of any other elements.

When a certain element is referred to as being “on (or under)” another element, the certain element may be disposed in contact with the upper surface (or lower surface) of the other element or an intervening element may be present between the other element and the certain element disposed on (or under) the other element.

Furthermore, it will be understood that when a certain element is referred to as being “connected to” or “coupled to” another element, these elements may be directly connected or coupled to each other, but an intervening element may be “interposed” therebetween, or the elements may be connected or coupled to each other via another element.

As is customary in the field, some exemplary embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some exemplary embodiments may be physically separated into two or more interacting and discrete blocks, units, and/or modules without departing from the scope of the inventive concepts. Further, the blocks, units, and/or modules of some exemplary embodiments may be physically combined into more complex blocks, units, and/or modules without departing from the scope of the inventive concepts.

Hereinafter, exemplary embodiments of the present invention will be described in more detail with reference to the accompanying drawings.

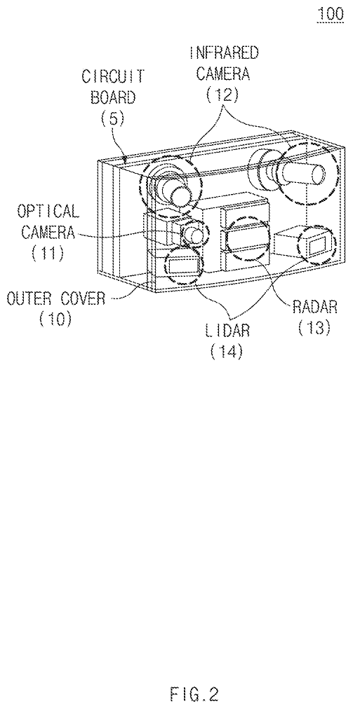

FIG. 2 is an outside view of an automotive sensor integration module according to an exemplary embodiment of the present invention.

An automotive sensor integration module according to an exemplary embodiment of the present invention may include a plurality of devices and sensors for detecting objects outside a vehicle to acquire safety information related to vehicle driving. In this case, the objects may include a lane, another vehicle, a pedestrian, a two-wheeled vehicle, a traffic signal, light, a road, a structure, a speed bump, a geographical feature, an animal, etc.

The lane may be a driving lane, a lane next to the driving lane, or a lane in which a vehicle is driving in the opposite direction. The lane may include left and right lines forming a lane.

Another vehicle may be a vehicle that is traveling in the vicinity of a host vehicle. The other vehicle may be a vehicle within a predetermined distance from the host vehicle. For example, the other vehicle may be a vehicle that is located within a predetermined distance from the host vehicle and precedes or follows the host vehicle.

The pedestrian may be a person in the vicinity of a host vehicle. The pedestrian may be a person located within a predetermined distance from the host vehicle. For example, the pedestrian may be a person on a sidewalk or the roadway within a predetermined distance from the host vehicle.

The two-wheeled vehicle may be a vehicle that is located in the vicinity of a host vehicle and moves using two wheels. The two-wheeled vehicle may be a vehicle that has two wheels and is located within a predetermined distance from the host vehicle. For example, the two-wheeled vehicle may include a motorcycle or a bicycle on a sidewalk or the roadway within a predetermined distance from the vehicle.

The traffic signal may include a traffic light, a traffic sign, a pattern or text drawn on a road surface.

The light may include light from a lamp in another vehicle, light from a street lamp, or light emitted from the sun.

The road may include a road surface, a curve, and a slope such as an upward slope and a downward slope.

The structure may be an object which is located around the road and fixed onto the ground. For example, the structure may include a streetlight, a roadside tree, a building, a power pole, a traffic light, a bridge, etc.

The geographical feature may include a mountain, a hill, etc.

Meanwhile, the objects may be classified into a moving object and a stationary object. For example, the moving object may conceptually include another vehicle, a two-wheeled vehicle, a pedestrian, etc., while the stationary object may conceptually include a traffic signal, a road, a structure, etc.

As such, it may be desirable to use various sensors and devices to accurately identify various objects around a vehicle.

In order to accurately identify objects outside a vehicle, an automotive sensor integration module 100 according to an exemplary embodiment of the present invention may include a plurality of different types of sensors and devices. In addition, the automotive sensor integration module 100 according to an exemplary embodiment of the present invention may include at least one sensor and device of the same type.

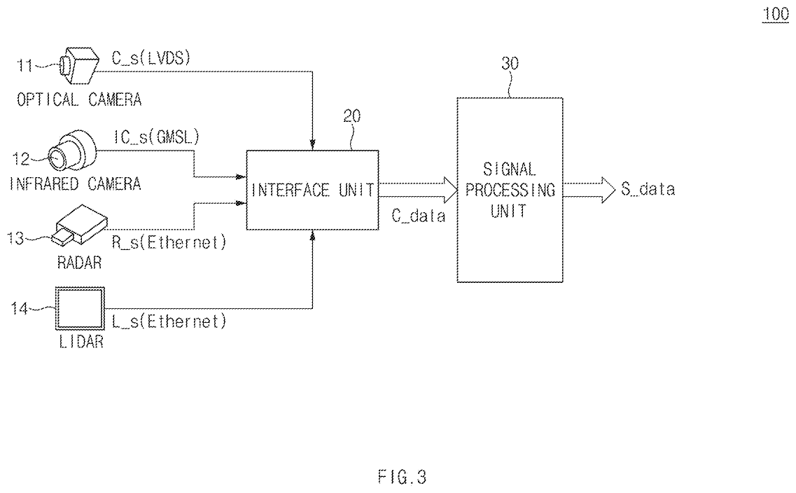

Referring to FIGS. 2 and 3, the automotive sensor integration module 100 according to an embodiment of the present invention may include an infrared camera 12, an optical camera 11, a lidar 14, and a radar 13 as a sensor to identify an object outside a vehicle. The automotive sensor integration module 100 according to an exemplary embodiment of the present invention illustrated in FIG. 2 is exemplarily shown to include an infrared camera 12, an optical camera 11, a lidar 14, and a radar 13 as a sensor in order to identify an object, but is not limited thereto. In addition, the automotive sensor integration module 100 according to an exemplary embodiment of the present invention illustrated in FIG. 2 shows two infrared cameras 12, one optical camera 11, two lidars 14, and one radar 13, but the number of each sensor is suggested only for illustrative purposes and is not limited thereto.

Referring to FIGS. 2 and 3, the automotive sensor integration module 100 according to an exemplary embodiment of the present invention may include a circuit board, an infrared camera 12, a camera 11, a radar 13, and a lidar 14. For example, the automotive sensor integration module 100 according to an exemplary embodiment of the present invention may include a circuit board on which an infrared camera 12, an optical camera 11, a radar 13, and a lidar 14 are disposed and mounted.

The optical camera 11 designed to acquire outside images of a vehicle through light and recognize objects, light, and people around the vehicle may include a mono camera, a stereo camera, an around view monitoring (AVM) camera, and a 360-degree camera. The optical camera 11 has advantages of being able to detect colors and accurately classify objects compared to other sensors, but has a disadvantage of being affected by environmental factors, such as darkness, backlight, snow, rain, fog, etc.

The radar 13 may detect an object on the basis of a time-of-flight (TOF) method or a phase-shift method through electromagnetic waves, and detect the location of a detected object, the distance to the detected object, and the relative speed. The radar 13 has an advantage of being capable of long distance detection without being affected by environmental factors such as darkness, snow, rain, fog, etc., but has a disadvantage of failing to detect an object, made of an electromagnetic wave-absorbing material, for example, a steel structure, such as a tunnel or a guardrail, and thus, being unable to classify objects.

The lidar 14 may detect an object on the basis of a TOF method or a phase-shift method through laser light, and detect the location of a detected object, the distance to the detected object, and the relative speed. The lidar 14 has advantages of being less affected by environmental factors such as night, snow, rain, fog, etc., efficient in long- and short-distance detection due to high resolution, and objects are able to be simply classified, but has a disadvantage of failing to measure the speed of objects immediately.

The infrared camera 12 may acquire outside images of a vehicle through infrared rays. In particular, the infrared camera 12 may acquire outside images of the vehicle even in darkness at night. The infrared camera 12 has advantages of being capable of long distance detection and distinguishment of living things from objects without being affected by environmental factors such as darkness, snow, rain, fog, etc. but has a disadvantage of being expensive.

The automotive sensor integration module 100 according to an exemplary embodiment of the present invention is configured such that an outer cover is coupled in the direction of the detection area of an optical camera 11, an infrared camera 12, a radar 13, and a lidar 14, that is, to the front surface of the automotive sensor integration module 100 to thereby protect the optical camera 11, the infrared camera 12, the radar 13, and the lidar 14 from physical shocks.

As such, in order to accurately classify and identify external objects around a vehicle regardless of environmental factors, the advantages and disadvantages of each sensor must be combined. Therefore, the automotive sensor integration module 100 according to an exemplary embodiment of the present invention discloses a structure in which a plurality of different sensors are all disposed and mounted on a circuit board. In addition, the automotive sensor integration module 100 according to an exemplary embodiment of the present invention may synchronize and output detection results of a plurality of sensors having different operation cycles, thereby having an advantage of classifying and identifying objects more accurately.

In this case, the automotive sensor integration module 100 may be connected to at least one or more devices disposed in the vehicle through the vehicle network communication. The vehicle network communication technology may include Controller Area Network (CAN) communication, Local Interconnect Network (LIN) communication, Flex-Ray® communication, Ethernet, and so on.

FIG. 3 is a diagram illustrating a configuration of an automotive sensor integration module according to an exemplary embodiment of the present invention.

Referring to FIG. 3, an automotive sensor integration module 100 according to an exemplary embodiment of the present invention may include an optical camera 11, an infrared camera 12, a radar 13, a lidar 14, an interface unit 20, and a signal processing unit 30. In this case, the interface unit 20 and the signal processing unit 30 may be implemented as hardware or software on the circuit board shown in FIG. 2.

The optical camera 11 may output information detected by medium of light as first detection data C_s.

The infrared camera 12 may output information detected by medium of infrared light as second detection data IC_s.

The radar 13 may output information detected by medium of electromagnetic waves as third detection data R_s.

The lidar 14 may output information detected by medium of laser light as fourth detection data L_s.

In this case, the optical camera 11, the infrared camera 12, the radar 13, and the lidar 14 may have different sensing (or operating) periods. For example, the optical camera 11 and the infrared camera 12 may have a sensing period of 30 Hz, and the radar 13 may have a sensing period of 20 Hz, and the lidar 14 may have a sensing period of 10 Hz.

Accordingly, the optical camera 11 and the infrared camera 12 may output the first and second detection data C_s and IC_s every first time (33 ms), and the radar 13 may output the third detection data R_s every second time (50 ms), and the lidar 14 may output the fourth detection data L_s every third time (100 ms).

In addition, communication standards of the detection data C_s, IC_s, R_s, and L_s respectively outputted by the optical camera 11, the infrared camera 12, the radar 13, and the lidar 14 may be different. For example, the first detection data C_s outputted by the optical camera 11 may be data of a format used in Low Voltage Differential Signal (LVDS) communication. The second detection data IC_s outputted by the infrared camera 12 may be data of a format used in Gigabit Multimedia Serial Link (GMSL) communication. The radar 13 and the lidar 14 may be data of a format used in Ethernet.

At least one or more sensors among the optical camera 11, the infrared camera 12, the radar 13, and the lidar 14 may output data values using a coordinate system different from coordinate systems of other sensors.

For example, the optical camera 11 and the infrared camera 12 may output the detection data C_s and IC_s having data values using a rectangular coordinate system. The rectangular coordinate system may include a two-dimensional rectangular coordinate system or a three-dimensional rectangular coordinate system. The two-dimensional coordinate system is a coordinate system formed by two straight lines perpendicular to each other (X-axis and Y-axis), and the three-dimensional rectangular coordinate system is a coordinate system formed by establishing a Z-axis perpendicular to each of the two axes (X-axis and Y-axis) of the two-dimensional rectangular coordinate system.

Also, the radar 13 and the lidar 14 may output the detection data R_s and L_s having data values using a curved coordinate system. The curved coordinate system may include a two-dimensional polar coordinate system or a three-dimensional polar coordinate system. The two-dimensional polar coordinate system is a coordinate system formed on the basis of a circle around an original point and a half-line passing through the original point, and the three-dimensional polar coordinate system is a coordinate system formed on the basis of a sphere around an origin point and a half-line passing through the origin point.

The interface unit 20 may convert the first-to-fourth detection data C_s, IC_s, R_s, and L_s having different data formats into one predetermined data format, and provide the converted detection data to the signal processing unit 30 as conversion data C_data. The interface unit 20 may convert the first-to-fourth detection data C_s, IC_s, R_s, and L_s into a data format according to a predetermined communication technology among vehicle network communication technologies.

In this case, the vehicle network communication technology may include Controller Area Network (CAN) communication, Local Interconnect Network (LIN) communication, Flex-Ray® communication, Ethernet, etc. For example, the interface unit 20 may convert the first-to-fourth detection data C_s, IC_s, R_s, and L_s into data of a format according to Ethernet communication.

The signal processing unit 30 may receive the first-to-fourth detection data C_s, IC_s, R_s, and L_s, the data formats of which have been converted by the interface unit 20, as the conversion data C_data. The signal processing unit 30 may convert the conversion data C_data into data values according to a predetermined coordinate system.

The signal processing unit 30 synchronizes the first-to-fourth detection data C_s, IC_s, R_s, and L_s, which have been converted into a predetermined data format and converted into data values according to a predetermined coordinate system, with a predetermined timing and outputs the synchronized detection data to an upper-level control device (not shown) as sensing data S_data. In this case, the upper-level control device may be a separate device for controlling the automotive sensor integration module 100, or may be a device included in an autonomous driving system or an advanced driver assistance system (ADAS) to determine objects or control driving of a vehicle.

For example, the signal processing unit 30 may convert each of the first-to-fourth detection data C_s, IC_s, R_s, and L_s converted into a predetermined data format into data values according to a predetermined coordinate system.

The signal processing unit 30 may output the first-to-fourth detection data C_s, IC_s, R_s, and L_s as sensing data S_data at the same timing on the basis of the input timing of one of the first-to-fourth detection data C_s, IC_s, R_s, and L_s converted into data values according to a predetermined coordinate system.

For a more detailed example, the signal processing unit 30 may be configured to receive and store the first-to-fourth detection data C_s, IC_s, R_s, and L_s converted into data values according to a predetermined coordinate system and output the stored first-to-fourth detection data C_s, IC_s, R_s, and L_s as sensing data S_data when a predetermined time has elapsed after the third detection data R_s was inputted to the signal processing unit 30. In this case, the sensing data S_data may include first-to-fourth detection data C_s, IC_s, R_s, and L_s respectively obtained from the optical camera 11, the infrared camera 12, the radar 13, and the lidar 14.

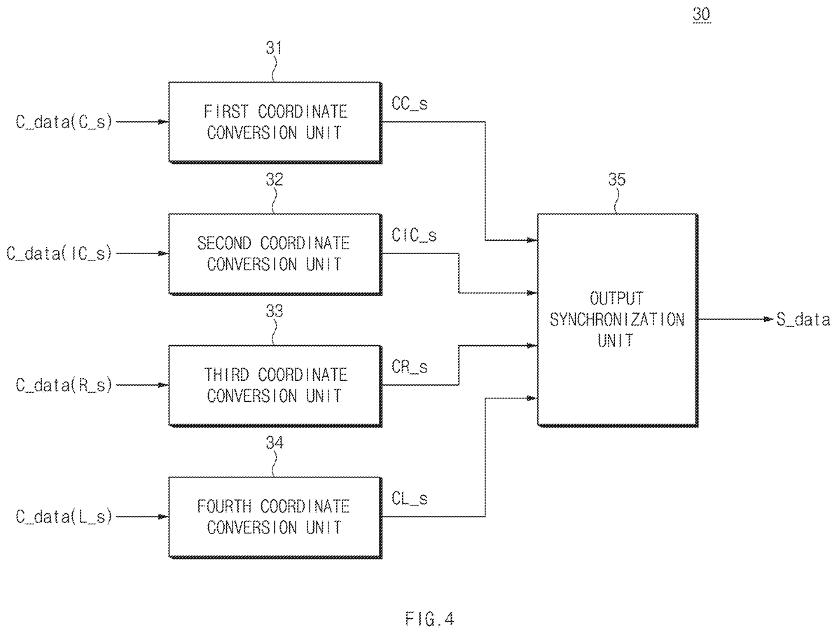

FIG. 4 is a diagram illustrating a configuration of the signal processing unit 30 of FIG. 3.

Referring to FIG. 4, the signal processing unit 30 may include first-to-fourth coordinate conversion units 31, 32, 33, and 34 and an output synchronization unit 35. In this case, the number of coordinate conversion units may correspond to the number of sensors included in the automotive sensor integration module 100 and this does not limit the number of coordinate conversion units shown in FIG. 4.

The first coordinate conversion unit 31 may convert the first detection data C_s included in the conversion data C_data on the basis of a predetermined coordinate system, and output the converted data value as the first coordinate conversion data CC_s.

The second coordinate conversion unit 32 may convert the second detection data IC_s included in the conversion data C_data on the basis of a predetermined coordinate system, and output the converted data value as the second coordinate conversion data CIC_s.

The third coordinate conversion unit 33 may convert the third detection data R_s included in the conversion data C_data on the basis of a predetermined coordinate system, and output the converted data value as the third coordinate conversion data CR_s.

The fourth coordinate conversion unit 34 may convert the fourth detection data L_s included in the conversion data C_data on the basis of a predetermined coordinate system, and output the converted data value as the fourth coordinate conversion data CL_s.

That is, the first-to-fourth coordinate conversion units 31, 32, 33, and 34 may respectively convert the first-to-fourth detection data C_s, IC_s, R_s, and L_s outputted from the optical camera 11, the infrared camera 12, the radar 13, and the lidar 14 on the basis of at least one predetermined coordinate system. In this case, each of the first-to-fourth coordinate conversion units 31, 32, 33, and 34 may be implemented as hardware or software to convert coordinates using interpolation.

It may be desirable that the first-to-fourth coordinate conversion units 31, 32, 33, and 34 convert the first-to-fourth detection data C_s, IC_s, R_s, and L_s, respectively, on the basis of the same coordinate system.

The output synchronization unit 35 may synchronize the first-to-fourth coordinate conversion data CC_s, CIC_s, CR_s, and CL_s inputted from the first-to-fourth coordinate conversion units 31, 32, 33, and 34, generate sensing data S_data, and output the generated sensing data. For example, the output synchronization unit 35 may synchronize the first-to-fourth coordinate conversion data CC_s, CIC_s, CR_s, and CL_s to output the sensing data S_data on the basis of any one of the first-to-fourth coordinate conversion data CC_s, CIC_s, CR_s, and CL_s.

In more detail, the output synchronization unit 35 may store each of the first-to-fourth coordinate conversion data CC_s, CIC_s, CR_s, and CL_s and output the stored first-to-fourth coordinate conversion data CC_s, CIC_s, CR_s, and CL_s as sensing data S_data when a predetermined time has elapsed after any one of the first-to-fourth coordinate conversion data CC_s, CIC_s, CR_s, and CL_s was inputted.

Automotive sensor integration module 100 according to the present invention configured as described above may convert the detection data C_s, IC_s, R_s, and L_s having different data formats and coordinate systems, which are outputted from the optical camera 11, the infrared camera 12, the radar 13, and the lidar 14, into a predetermined data format and a predetermined coordinate system, and output theses as the sensing data S_data at the same timing.

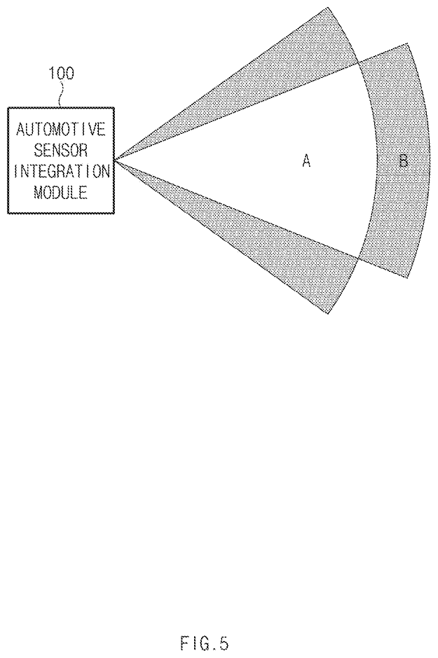

FIG. 5 is a diagram for explaining an automotive sensor integration module according to an embodiment of the present invention.

As described above, the automotive sensor integration module according to the exemplary embodiment of the present invention may include a plurality of sensors, such as the optical camera 11, the infrared camera 12, the radar 13, and the lidar 14.

Since the optical camera 11, the infrared camera 12, the radar 13 and the lidar 14 may have different detection ranges, that is, detection distance and Field-Of-View (FOV), the automotive sensor integration module 100 according to an exemplary embodiment of the present invention may convert the output of each sensor to the same data format and the same coordinate system to provide the converted output to a upper-level control device, so that as shown in FIG. 5, the upper-level control device may give higher reliability to detection data according to overlapping detection areas A than detection data for non-overlapping detection areas B.

Since the upper-level control device that receives the output of the automotive sensor integration module 100 according to the present invention receives the output of the sensors converted into the same data format and the same coordinate system, the upper-level control device may compare the outputs of the sensors with each other to give high reliability to the overlapping data and identify an object on the basis of the data given high reliability.

Therefore, it is possible to improve the object identification performance of the autonomous driving system or the ADAS system to which the automotive sensor integration module 100 according to the present invention is applied.

Since the automotive sensor integration module according to an exemplary embodiment of the present invention converts the coordinate system of the detection data outputted by the plurality of sensors into a predetermined coordinate system and outputs the predetermined coordinate system, it is possible to improve the performance of detecting objects outside a vehicle.

In addition, since the automotive sensor integration module according to an exemplary embodiment of the present invention converts the coordinate system of the output data outputted by the plurality of sensors into a predetermined coordinate system and outputs the predetermined coordinate system, the reliability of the detection data converted into the predetermined coordinate system can be distinguished, thereby improving the performance of detecting objects outside a vehicle.

Although the present invention has been described with reference to the drawings exemplified as above, the present invention is not limited to the embodiments and drawings disclosed herein, and it would be obvious that various modifications may be made by those skilled in the art within the scope of the technical spirit of the present invention. Furthermore, it is apparent that, although the effects brought about by the configuration of the present invention are not clearly mentioned while describing the embodiments of the present invention, any effect, which can be predicted from the configuration, can also be acknowledged.

What is claimed is:

1. An automotive sensor integration module comprising:
a plurality of sensors differing from each other in at least one of a sensing period or an output data format;
an interface unit configured to convert pieces of detection data outputted from the plurality of sensors into a predetermined data format and output the converted detection data as conversion data; and
a signal processor configured to convert the conversion data into data according to a predetermined coordinate system to generate a plurality of pieces of conversion data, and synchronize and output the conversion data on the basis of any one of the plurality of pieces of conversion data.

2. The automotive sensor integration module of claim 1, wherein the signal processor receives the pieces of detection data converted into the predetermined data format as the conversion data, and converts each of the pieces of detection data converted into the predetermined data format into data according to the predetermined coordinate system to generate each of the plurality of pieces of conversion data.

3. The automotive sensor integration module of claim 2, wherein the signal processor receives and stores the plurality of pieces of conversion data, and simultaneously outputs the stored conversion data on the basis of the sensing period of any one of the plurality of pieces of conversion data.

4. The automotive sensor integration module of claim 3, wherein the signal processor comprises:
a plurality of coordinate conversion units configured to receive each of the pieces of detection data converted into the predetermined data format and generate each of the plurality of pieces of conversion data; and
an output synchronization unit configured to receive and store the plurality of pieces of conversion data, and simultaneously output the plurality of pieces of stored conversion data when a predetermined time has elapsed after any one of the plurality of pieces of conversion data is inputted.

5. The automotive sensor integration module of claim 4, wherein each of the plurality of coordinate conversion units converts the pieces of detection data converted into the predetermined data format into data according to the predetermined coordinate system.

6. The automotive sensor integration module of claim 1, wherein the interface unit converts the pieces of detection data into one predetermined data format and outputs the converted detection data as the conversion data.
